(19) United States
(12) Patent Application Publication
(10) Pub. No.: US 2005/0264521 A1
(43) Pub. Date: Dec. 1, 2005

(54) Multimode key system

(76) Inventors: Yu-Chun Liu, Taipei Hsien (TW); Mei-Chen Lu, Taipei Hsien (TW)

Correspondence Address: Yu-Chun Liu, 235 Chung-Ho, Box 8-24, Taipei, TW

(21) Appl. No.: 10/942,331

(22) Filed: Sep. 16, 2004

(30) Foreign Application Priority Data
May 25, 2004 (TW) 93114827

(51) Int. Cl. G09G 5/00

(52) U.S. Cl. 345/156

(57) ABSTRACT

A multimode key system provides a multiple of keys for multimode control, wherein only desired function keys are shown on the control panel at a time, and whereby the operation thereof can be much simplified. The key system can be a touch panel or a pressure sensing panel, which characterized in a shifting unit integrated with an outer shell. The shifting unit can shift the a printed keyboard or a keyboard display grid board, so that the windows on the grid board display a set of corresponding keys on the printed keyboard, and thereby a user can see and touch the keys to operate a corresponding appliance or an industrial device.

### FIELD OF THE INVENTION

The present invention relates to multimode key systems, and more particularly to a multimode key system for a control device so that the control device can control a plurality of electric appliances or industrial apparatuses.

### BACKGROUND OF THE INVENTION

A controller of the prior art is for activating various functions of a device by touching the keys on the controller. For example, a television controller controls channel, volume, frame freezing, frame division, etc. Upon the progress of technology, the present home appliances tend to have multiple purposes, such as an LCD display can be a common displaying device for a computer, a television, an Internet device and an audio-video player. Thereby, a consumer can enjoy a variety of audio-video appliances using only one displaying device. On the other hand, given the increasing number of home appliances available for a consumer, it is necessary to have a single controller capable of controlling a plurality of devices. However, because of the increase in functions of a single home appliance and the increase in types of home appliances available to a common consumer, a controller capable of controlling a plurality of devices has the problems of large panel area, operational complexity and therefore high production cost.

According to the problem of having too many keys and being inconvenient to use especially for conventional multimode controllers. The multimode controllers with an LCD touch panel are introduced to solve the problems, but it has disadvantages of high production cost and fragility, therefore difficult to promote.

By the same token, similar problems occur in the keypad systems and control panels for various electric or electronic appliances and commercial or industrial apparatuses.

### SUMMARY OF THE INVENTION

Accordingly, the primary objective of the present invention is to provide a multimode key system aiming to solve the problems of having too many keys, having too large a control panel area, operational complexity and high production cost of a conventional multimode controller.

The secondary objective of the present invention is to provide a multimode key system applicable to either single-device multimode control or multi-device multimode control. The multimode key system is tougher, more durable and cheaper than a conventional LCD multimode touch key controller.

It is a further objective of the present invention that it can utilize touch panel mode or pressure sensing mode and therefore can be used in a variety of home appliances and industrial devices.

Therefore, the present invention leads to the following advantages:
1. simplifying the complicated bulky key system by showing the desired control mode once at a time;
2. being applicable to an extended variety of controllers, keypad systems and control panels of home appliances and industrial devices;
3. keypad mechanism thereof being flexible to be embodied in touch panel mode and pressure sensing mode, and key picture switching mechanism being push rod, knob, roller wheel, joystick or push buttons;
4. having colored printed keyboard, which is much cheaper than using colored LCD panels;
5. being of tougher structure than an LCD multimode key system; and
6. being able to provide a plurality of touch key windows at lower cost and therefore a simplified control interface.

To achieve above objects, the present invention provides a multimode key system, which comprises an outer shell with at least one viewing window; a shifting unit combined with the outer shell for a user to operate; a sensing circuit module hidden within the outer shell; a movable plate disposed in the outer shell coupled with the shifting unit, whereby the movable plate can be moved by shifting the shifting unit, and an immovable plate situating a corresponding parallel position of the movable plate to form a moving mechanism; whereby, one of above plates being a keyboard display grid board with a plurality of display windows formed at predetermined locations; and second plate situating under or behind previous plate in a slidable contact, being a printed keyboard having a plurality of sets of key pictures. The shifting unit can urge the movable plate to move so as to form a slide dislocation between the movable plate and the immovable plate, and whereby any set of key pictures can be selected to appear in the display windows on the immovable plate for switching the multimode key system to a desired control mode.

The various objects and advantages of the present invention will be more readily understood from the following detailed description when read in conjunction with the appended drawings.

### BRIEF DESCRIPTION OF THE DRAWINGS

FIGS. 1A˜1C is a perspective view of the first preferred embodiment of the present invention.

FIG. 2 is an exploded perspective view of the first preferred embodiment of the present invention.

FIGS. 3A˜3C illustrate the operation of the first preferred embodiment of the present invention.

FIG. 4 is an exploded perspective view of the second preferred embodiment of the present invention.

FIGS. 5A˜5E illustrate the operation of the third preferred embodiment of the present invention.

FIGS. 6A˜6F illustrate the operation of the fourth preferred embodiment of the present invention.

FIGS. 7A and 7B illustrate the operation of the fifth preferred embodiment of the present invention.

FIGS. 8A˜8F illustrate the operation of the sixth preferred embodiment of the present invention.

FIGS. 9A and 9B illustrate the operation of the seventh preferred embodiment of the present invention.

FIGS. 10A and 10B illustrate the operation of the eighth preferred embodiment of the present invention.

FIGS. 11A and 11B illustrate the operation of the ninth preferred embodiment of the present invention.

FIG. 12 is an exploded perspective view of the tenth preferred embodiment of the present invention.

FIG. 13A illustrates the moving mechanism of the tenth preferred embodiment of the present invention.

FIGS. 13B and 13C illustrate the operation of the tenth preferred embodiment of the present invention.

FIG. 14 is a top view of the eleventh preferred embodiment of the present invention.

FIG. 15 is an exploded perspective view of the twelfth preferred embodiment of the present invention.

FIGS. 16A˜16D illustrate the operation of the twelfth preferred embodiment of the present invention.

FIGS. 17A and 17B illustrate the operation of the thirteenth preferred embodiment of the present invention.

FIGS. 18A and 18B illustrate the operation of the fourteenth preferred embodiment of the present invention.

FIG. 19 is a top view of the fifteenth preferred embodiment of the present invention.

### DETAILED DESCRIPTION OF THE PREFERRED EMBODIMENTS

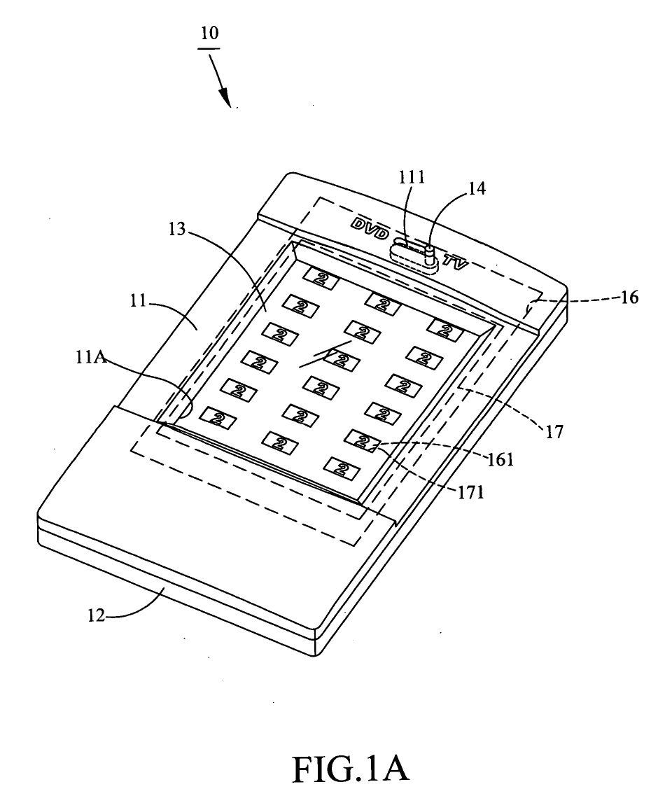

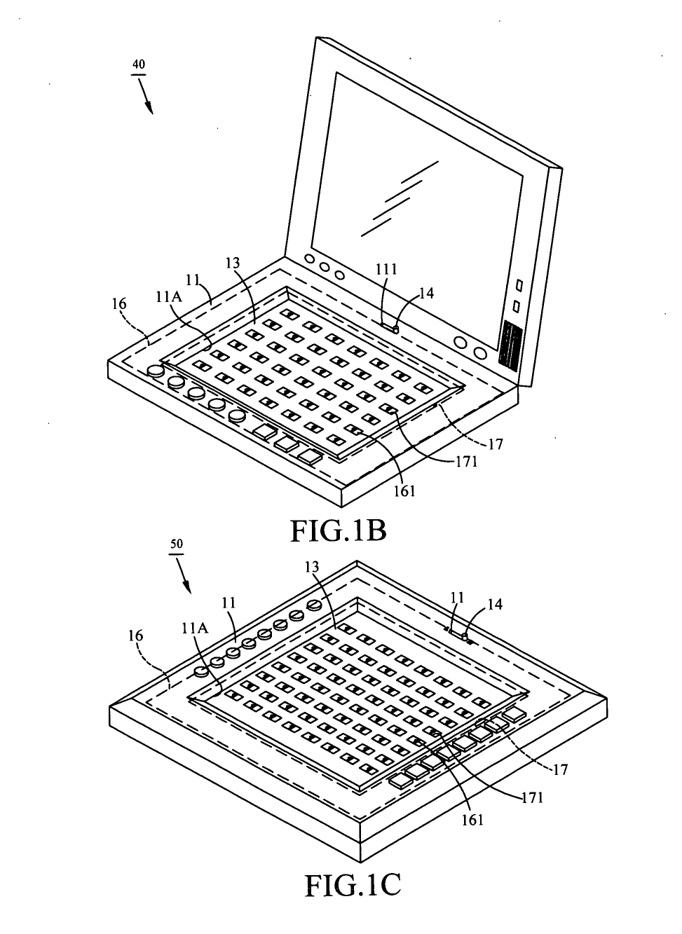

Referring to FIG. 1A, a remote controller 10 according to the present invention, such as wired or wireless hand-held controllers used with televisions, stereo equipments, VCR, multimedia players and toys, comprises an outer shell composed of an upper cover 11 and a lower cover 12, which outer shell is provided with at least one viewing window 11A. The remote controller 10 further includes shifting unit comprising a control knob 14 and a track slot 111, a sensing circuit hidden within the outer shell and a movable plate 16 situating within the outer shell. After coupling the movable plate 16 with the shifting unit, the movement of the movable plate 16 is then controlled by the control knob 14. An immovable plate situating a corresponding parallel position of the movable plate to form a moving mechanism. The remote controller 10 further comprises this immovable plate 17 above the movable plate 16 and is provided with a multitude of display windows 171. On the other hand, the movable plate 16 is provided with a printed keyboard having a plurality of key pictures 161. The control knob 14 of the shifting unit can be pushed to activate a corresponding sliding motion of the movable plate 16, whereby desired key pictures 161 can be displayed in the display windows 171 of the immovable plate 17. Therefore, the shifting unit of the remote controller 10 can switch in among preset control modes.

Referring to FIG. 1B, the multimode key system according to the present invention can also be used to be the control/operation keyboard of an electric or electronic appliance 40, such as a language translator, a calculator, a microwave oven, an electromagnetic oven and a refrigerator.

Referring to FIG. 1C, the multimode key system according to the present invention can also be used to be the keyboards or touch panels 50 of an industrial device, such as the control panel of a treadmill, the control panel of an electric door, the control panel of a machine and the switchboard of a fire fighting center.

Therefore, the application of a multimode key system according to the present invention can be very extensive. A variety of preferred embodiments are provided as follows.

### The First Preferred Embodiment

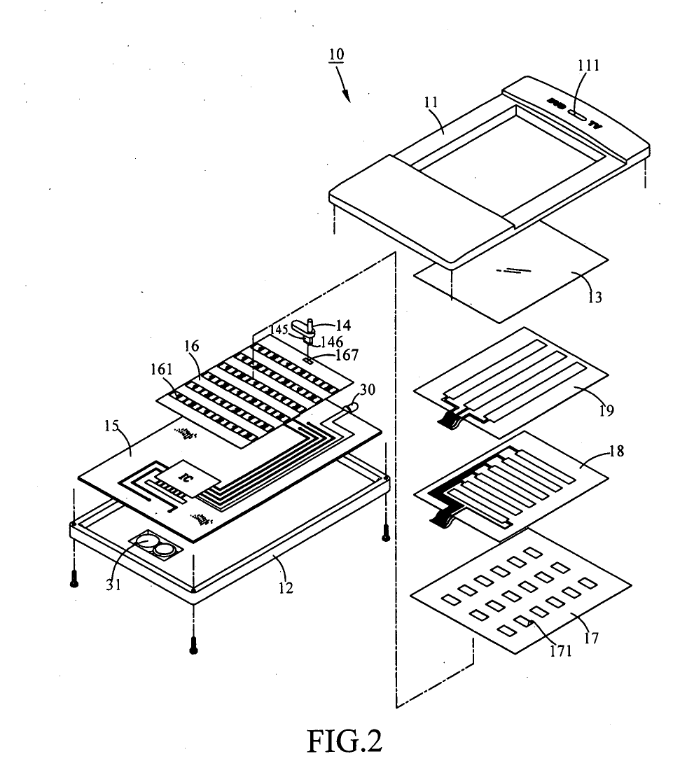

FIG. 2 is a corresponding exploded view of the remote controller 10 in FIG. 1A, which is a dual mode (the control knob 14 may turn left and right), touch screen keypad system. The remote controller 10 comprises an outer shell formed by an upper cover 11 and a lower cover 12, a transparent screen protection cover 13 attached onto a viewing window of the outer shell, a shifting unit formed by a control knob 14 confined by a track slot 111 on the outer shell, a sensing circuit module housed within the outer shell and having a keypad circuit board 15 provided with an infrared transmitter and a set of transverse and longitudinal sensing pieces 18, 19, a movable plate 16 connected to the control knob 14 and being a printed keyboard in this case, and an immovable plate 17 which is a keyboard display grid board in this case. The upper immovable plate 17, being a keyboard display grid board 17 provided with a multitude of display grids 171, is right above the lower movable plate 16, which is a printed keyboard 16 provided with colored or black/white key pictures 161.

The above sensing circuit module comprises a keypad circuit board 15 and a set of transverse and longitudinal sensing pieces 18, 19 situating between the keyboard display grid board 17 and the transparent screen protection cover 13. Positions of the transverse and longitudinal sensing pieces 18, 19 can be swapped or even being integrated as one piece, the lower ends of which are provided with flat cables connected to an IC element on the keypad circuit board 15. The structure of the sensing circuit module can be replaced by a touch screen system of similar functions.

In this preferred embodiment, the transverse sensing piece 18 and the longitudinal sensing piece 19 is a set of touch sensing pieces which connected to the key circuit module 15. They can sense pressure in the vertical (X) direction and the horizontal (Y) direction and convert the signal into a control command after calculation. Since this technology belongs to prior art and not in the scope of the present invention, we will discuss its principle no more.

The keypad circuit module 15 is powered by a battery 31 and is for detecting both key stroke and a change in control mode as activated by the control knob 14, and the keystroke of a user is detected by the transverse and longitudinal sensing pieces 18, 19, processed by the IC and then output by an infrared LED 30 as a control command. The function of multimode control is thus achieved.

Acting like a push rod, the above-mentioned control knob 14 is mounted on the upper end of a printed keyboard 16 by using a support post 145 to connect the control knob 14 and a through hole 167 on the printed keyboard 16. The bottom end of the support post 145 is plated With a silicon electrode 146 for electrically connecting the keypad circuit board 15, so that the keypad circuit board 15 can switch to a distinct command set for a desired control mode. The location where the control knob 14 is fixed can be selected from a left end, a right end, a bottom end and a lateral end on the printed keyboard 16; therefore, in this specification, it is not necessary to specify the exact location of the control knob 14 and the track slot 111 on the outer shell of the remote controller 10. Further, the track slot 111 corresponding to the control knob 14 can extend on the outer shell transversely, vertically or obliquely, as long as the control knob 14 it confines can drive the printed keyboard 16 accordingly.

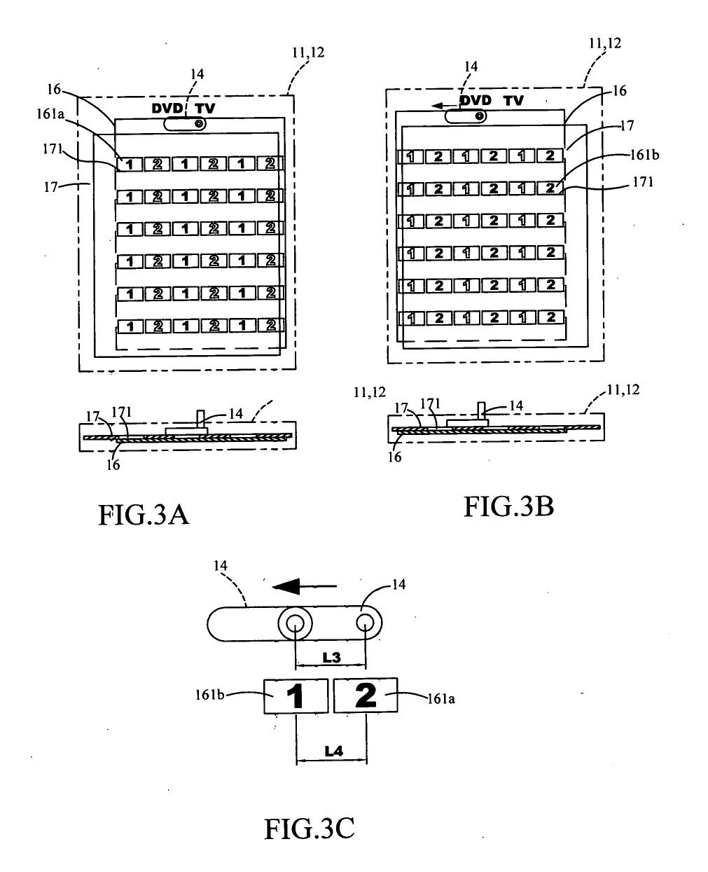

The above-mentioned keyboard display grid board 17 is secured on the outer shell, having an area larger than the printed keyboard 16 so as to cover the surface of the printed keyboard 16. The key pictures 161 are printed at predetermined locations on the printed keyboard 16, so that a desired set thereof can show up in the display windows 171 of the keyboard display grid board 17 as the printed keyboard 16 is moved to a predetermined location under the keyboard display grid board 17. As shown in FIG. 3A, before the control knob 14 moves, the windows 171 on the keyboard display grid board 17 display the key pictures 161a labeled “1”. In FIG. 3B, the control knob 14 moves to the right, and the display windows 171 on the keyboard display grid board 17 now display the key pictures 161b labeled “2”. If the control knob 14 is turned to the left again, the display mode will recover to what is shown in FIG. 3A.

Referring to FIG. 3C, if the control knob 14 moves over a distance of L3 to switch control mode, the distance L4 between the key pictures 161a and the key pictures 161b, in the direction of the movement, must be equal to L3. Suppose the remote controller 10 has the key pictures 161a and the key pictures 161b respectively for controlling a television set and a DVD player, the key pictures 161b will be covered by the keyboard display grid board 17 before the control knob 14 moves; a user can neither see nor control the DVD player. After the control knob 14 is turned to the right, the key pictures 161a will be concealed by the keyboard display grid board 17; a user can neither see nor control the television set. Therefore, the remote controller 10 achieves a dual mode remote control by turning the control knob 14 left and right.

By the same token, if the track slot 111 extends vertically on the outer shell, the movement of the control knob 14 will be vertical, and the printed keyboard 16 will move in the same direction accordingly. If the track slot 111 extends 45 degrees obliquely on the outer shell, the movement of the control knob 14 will be 45 degrees obliquely, and the printed keyboard 16 will move in the same direction accordingly.

As another flexibility, the shifting unit can be the control knob 14 being mounted on the keyboard display grid board 17 and the printed keyboard 16 being the immovable plate. Thereby, the keyboard display grid board 17 moves with the control knob 14. Although the movement of the shifting unit is different, the relative position and motion between the printed keyboard 16 and the keyboard display grid board 17 remain the same; that is, the key pictures 161a and the key pictures 161b of the printed keyboard 16 can be switched to show up in the display windows 171 on the keyboard display grid board 17 in a similar fashion.

To summarize, the preferred embodiments of the present invention utilizes a control knob 14 to activate a sliding motion of either one of the printed keyboard 16 and the keyboard display grid board 17 so that a relative sliding occurs between the printed keyboard 16 and the keyboard display grid board 17, whereby different sets of key pictures 161 can appear for a user to control a selected device.

### The Second Preferred Embodiment

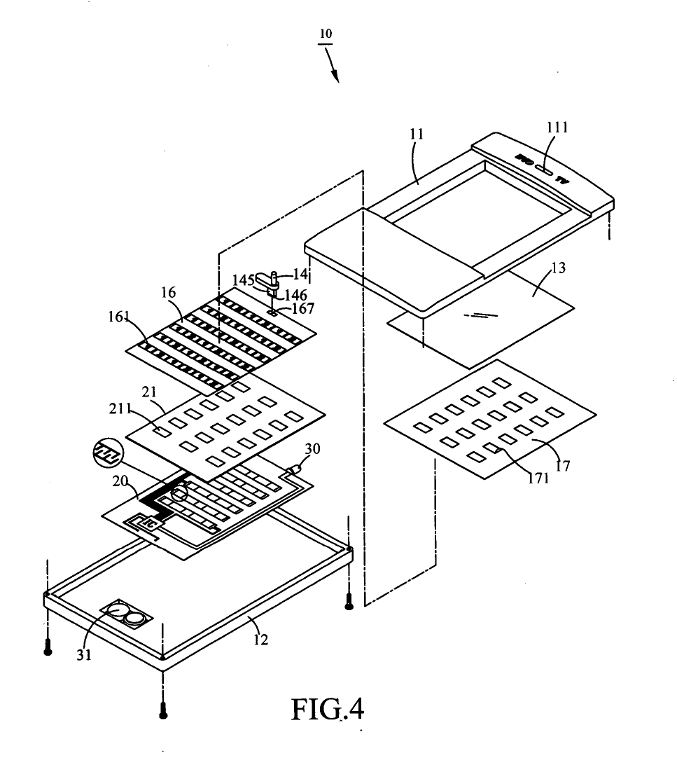

This preferred embodiment is a dual-mode, pressure sensing keypad system. Referring to FIG. 4, the second preferred embodiment is a multimode remote controller 10 with a plurality of pressure sensing keys. The remote controller 10 comprises an outer shell formed by an upper cover 11 and a lower cover 12, a transparent screen protection cover 13 attached onto a viewing window of the outer shell, a shifting unit formed by a control knob 14 confined by a track slot 111 on the outer shell, a sensing circuit module housed within the outer shell and having a keypad sensing circuit board 20 and a pressure key activation plate 21, a movable plate 16 which is a printed keyboard in this case, situating in the outer shell and connected to the control knob 14, and an immovable plate 17 which is a keyboard display grid board in this case. The immovable plate 17, being a keyboard display grid board 17 provided with a multitude of display windows 171, is right above the movable plate 16, which is a printed keyboard 16 provided with colored or black/white key pictures 161. The printed keyboard 16 situates above the, pressure key activation plate 21.

The major difference between the first preferred embodiment and the second preferred embodiment is the sensing circuit module. In the latter case, the sensing circuit module comprises a pressure key activation plate 21 located under the printed keyboard 16 and a pressure key sensing circuit board 20, whereby a user presses the key pictures 161 on the printed keyboard 16 so as to activate the corresponding keys 211 on the pressure key activation plate 21, in turn producing a control command in the pressure key sensing circuit board 20. Further, one of the printed keyboard 16 and the keyboard display grid board 17 is a movable plate, and the other is an immovable plate. The relative sliding motion between the movable and the immovable plates realizes the control mode switching, which is of the same principle as the first preferred embodiment and therefore will be described no more. Therefore, as the control knob 14 is shifted, the set of key pictures 161 shown in the display windows 171 switches to another set that corresponds to a different control mode.

### The Third Preferred Embodiment

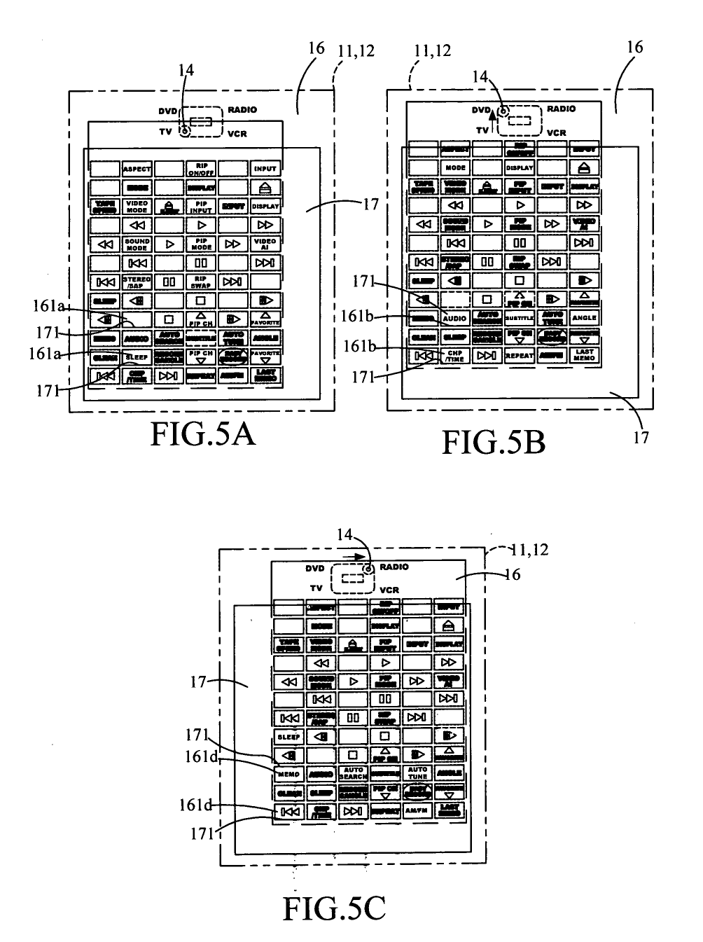

This preferred embodiment is a four mode keypad system with a rectangular shifting track. As shown in FIG. 5, the interaction between a printed keyboard 16, a keyboard display grid board 17 and the control knob 14 of the third preferred embodiment of the present invention is illustrated, which can be used in a touch screen or a pressure sensing panel. The difference of this preferred embodiment from the previous ones is that the track slot 111 is a self-closed rectangular track, where the control knob 14 is confined to follow a rectangular moving path. Referring to FIG. 5A wherein the control knob 14 is located at a point labeled “TV” on the upper cover 11. Therefore, the display windows 171 of the keyboard display grid board 17 and the TV key pictures 161a on the printed keyboard 16 are overlapped, so that a user can only control a corresponding television set by either touch screen or a pressure sensing panel.

As shown in FIG. 5B, as the control knob 14 proceeds to move to the top, switched to a location labeled “DVD”, the display windows 171 of the keyboard display grid board 17 and the DVD key pictures 161b on the printed keyboard 16 are overlapped, so that a user can only control a corresponding DVD player by either touch screen or a pressure sensing panel.

As shown in FIG. 5C, as the control knob 14 proceeds to move to the right, switched to a location labeled “RADIO”, the display windows 171 of the keyboard display grid board 17 and the RADIO key pictures 161c on the printed keyboard 16 are overlapped, so that a user can only control a corresponding RADIO player by either touch screen or a pressure sensing panel.

As shown in FIG. 5D, as the control knob 14 proceeds to move to the bottom, switched to a location labeled “VCR”, the display windows 171 of the keyboard display grid board 17 and the VCR key pictures 161d on the printed keyboard 16 are overlapped, so that a user can only control a corresponding VCR player by either touch screen or a pressure sensing panel.

If the control knob 14 proceeds to move to the left back to the location indicating “TV”, the control knob 14 has shifted along the rectangular track for a complete round, and the control mode is restored to the status in FIG. 5A. Therefore, the display windows 171 of the keyboard display grid board 17 and the TV key pictures 161a on the printed keyboard 16 are overlapped, so that a user can only control a corresponding television set by either touch screen or a pressure sensing panel.

To facilitate a user to recognize different control modes, the TV key pictures 161a can be colored orange, the DVD key pictures 161b can be colored blue, the RADIO key pictures 161c can be colored yellow and the VCR key pictures 161d can be colored green. Therefore, four color codes respectively represent four different control modes, which can be easily recognized by a user.

Referring to FIG. 5E, if the control knob 14 moves longitudinally over a distance of L1 to switch control mode, the dislocation distance L2 between two key pictures, in the longitudinal direction of the movement, must be equal to L1. If the control knob 14 moves transversely over a distance of L3 to switch control mode, the dislocation distance L4 between two key pictures, in the transverse direction of the movement, must be equal to L3. Therefore, the remote controller 10 houses four sets of key pictures, so that the remote controller 10 can support four remote control modes.

### The Fourth Preferred Embodiment

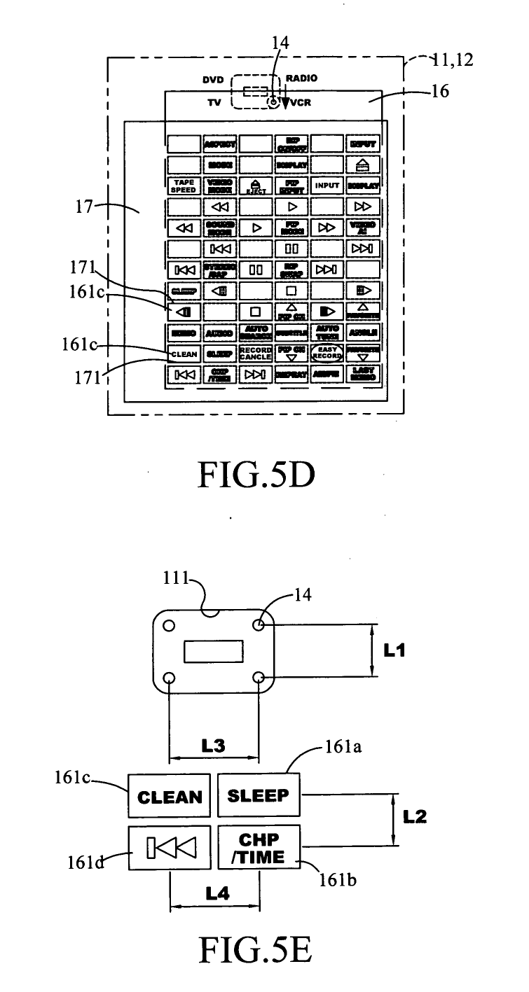

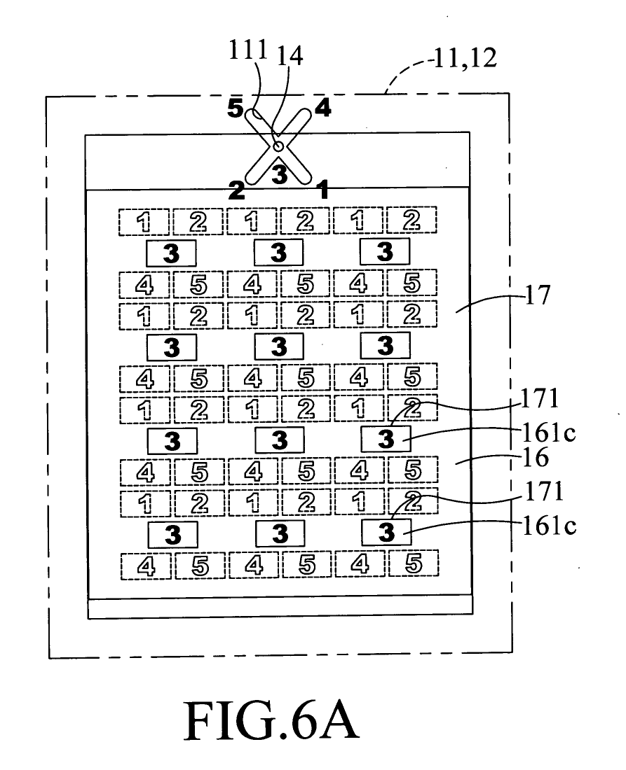

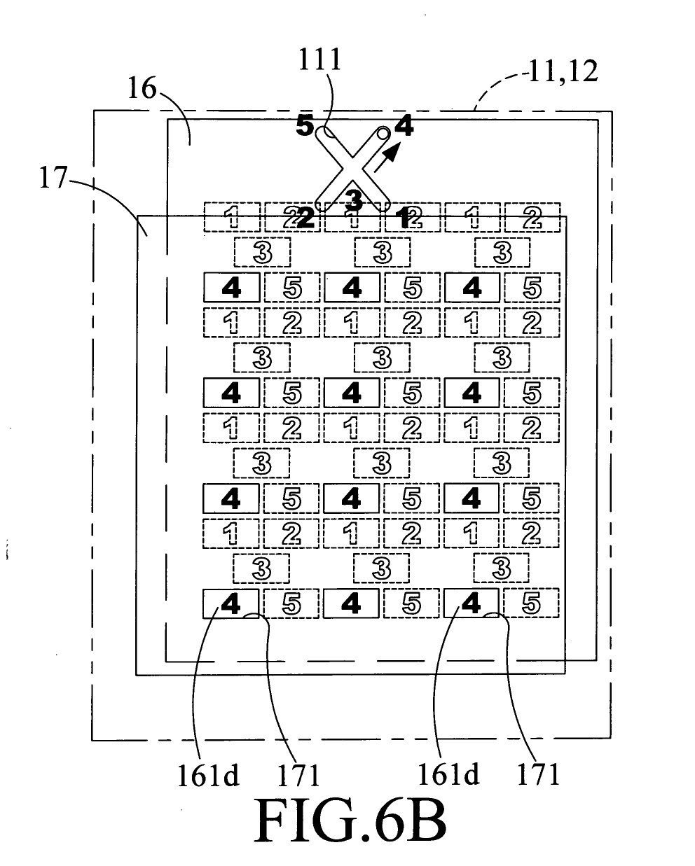

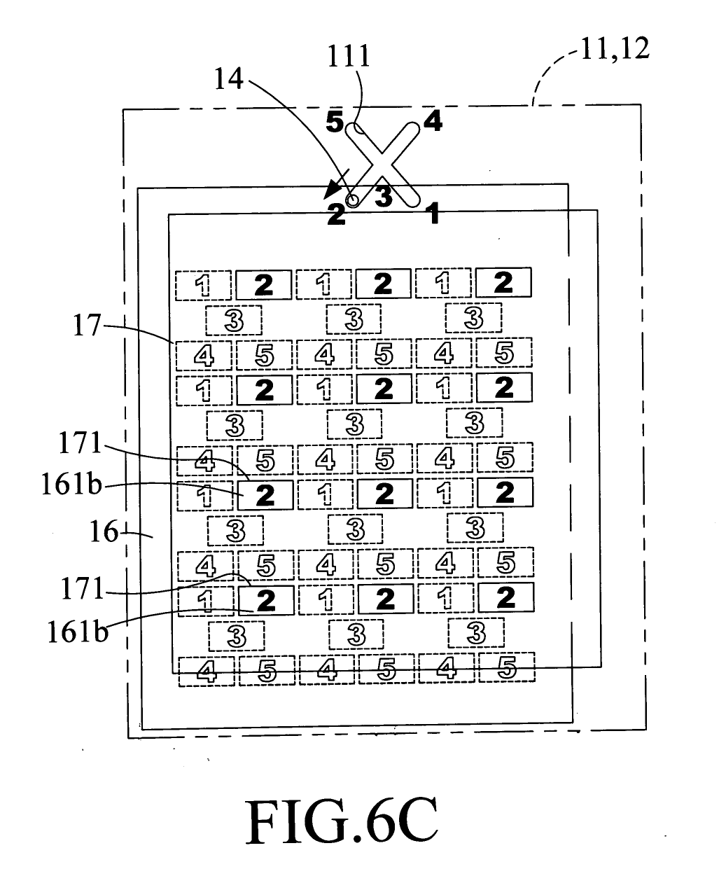

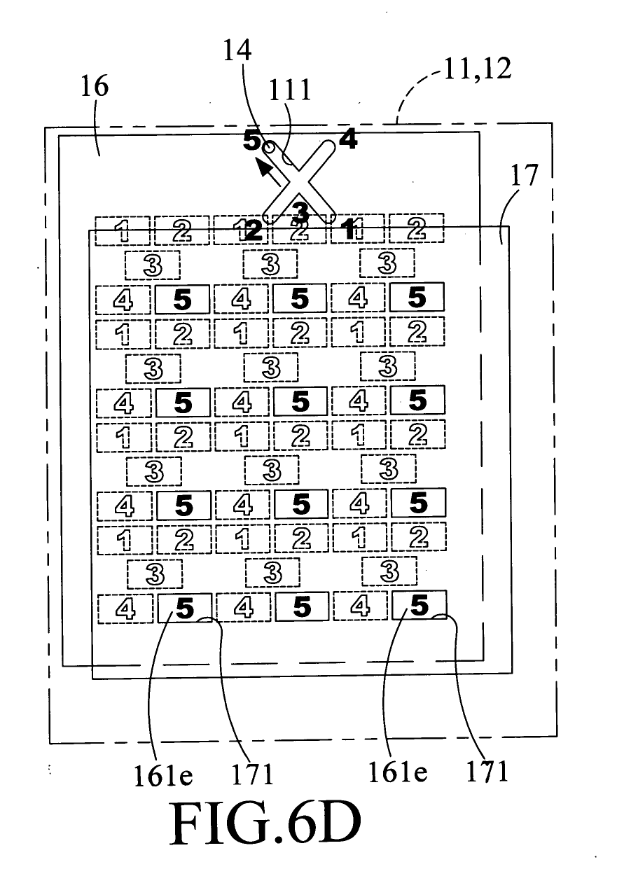

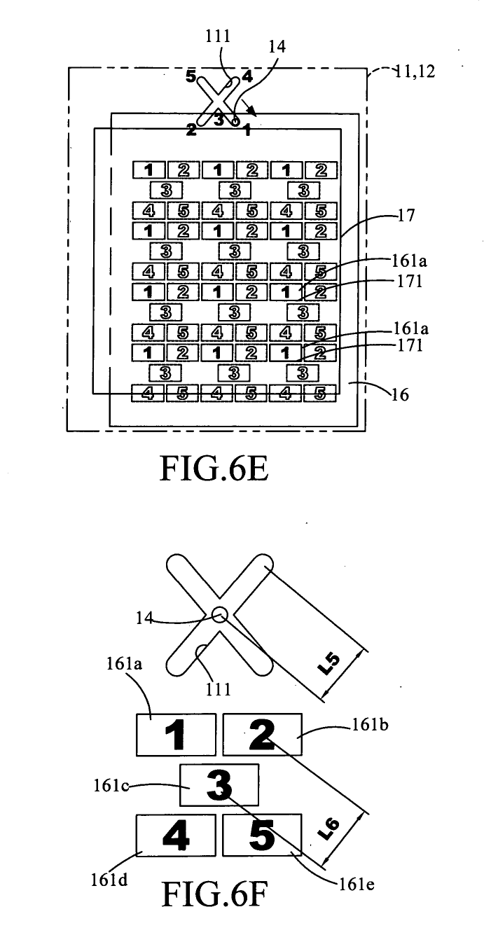

This preferred embodiment is a five mode keypad system with a cross shifting track. As shown in FIG. 6, the physical relation between a printed keyboard 16, a keyboard display grid board 17 and the control knob 14 of the fourth preferred embodiment of the present invention is illustrated, wherein the track slot 111 takes a cross shape. The center and four ends of the cross track indicate five control modes. As shown in FIG. 6A, the control knob 14 is at the center, and the display windows 171 of the keyboard display grid board 17 and the key pictures 161c on the printed keyboard 16 are overlapped.

As shown in FIG. 6B, the control knob 14 is at the upper right end, and the display windows 171 of the keyboard display grid board 17 and the key pictures 161d on the printed keyboard 16 are overlapped.

As shown in FIG. 6C, the control knob 14 is at the lower left end, and the display windows 171 of the keyboard display grid board 17 and the key pictures 161b on the printed keyboard 16 are overlapped.

As shown in FIG. 6D, the control knob 14 is at the upper left end, and the display windows 171 of the keyboard display grid board 17 and the key pictures 161e on the printed keyboard 16 are overlapped.

As shown in FIG. 6E, the control knob 14 is at the lower right end, and the display windows 171 of the keyboard display grid board 17 and the key pictures 161a on the printed keyboard 16 are overlapped.

As shown in FIG. 6F, if the distance taken for the control knob 14 to move form the center to any of the ends of the cross track is L5, the dislocation distance of any two adjacent set of key pictures in the diagonal direction L6 must equal to L5. Thereby, the remote controller 10 can have five control modes.

### The Fifth Preferred Embodiment

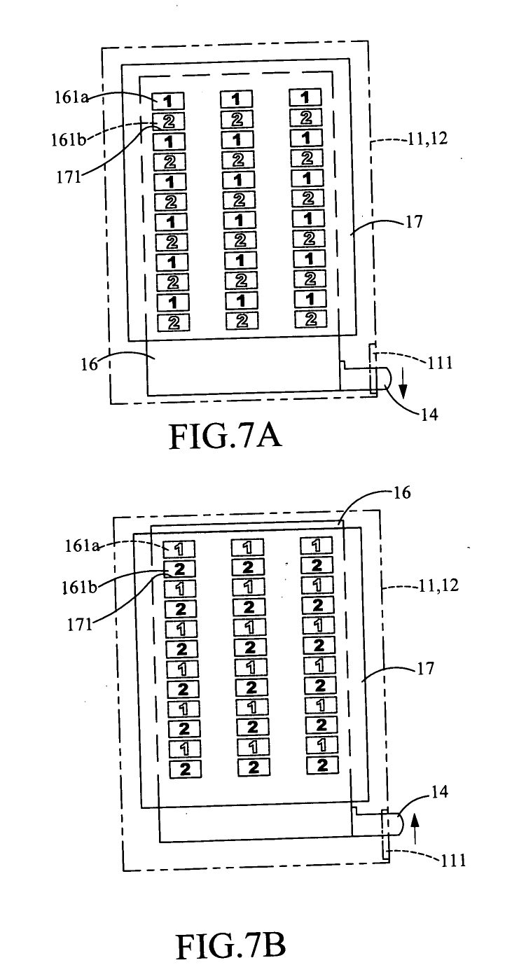

Referring to FIGS. 7A and 7B, the fifth preferred embodiment of the present invention as a multimode key system may have the track slot 111 of the shifting unit disposed at another location on the outer shell, such as a lateral portion of the upper cover 11 or the lower cover 12, where the control knob 14 can go through. The control knob 14 not only controls the up/down but also the left/right shifts of the printed keyboard 16 accordingly. The exact location of the shifting unit (comprises a track slot 111 and a_control knob 14 in this preferred embodiment) can be flexible, as long as they can achieve the desired function.

### The Sixth Preferred Embodiment

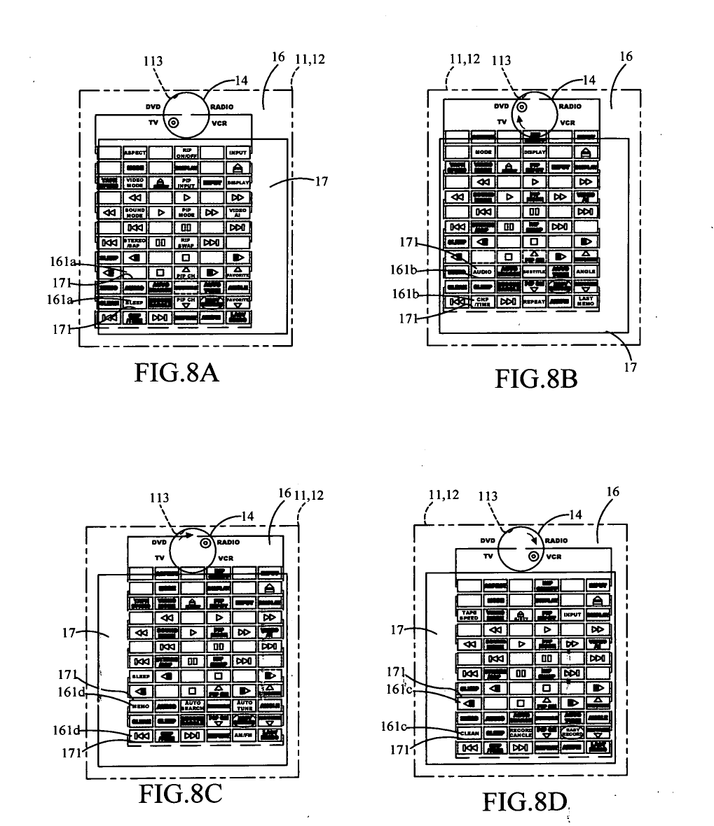

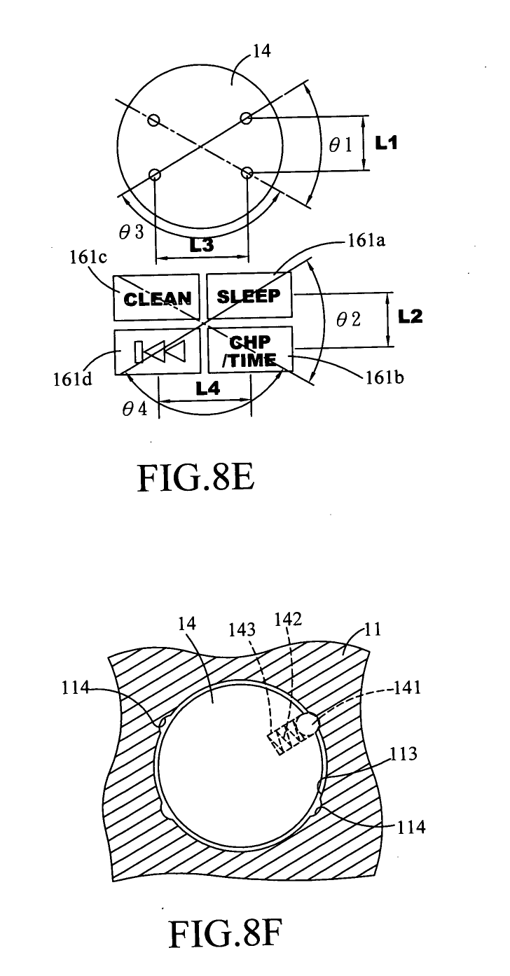

This preferred embodiment is a four mode key system with a circular shifting unit. As shown in FIG. 8, the physical relation between a printed keyboard 16, a keyboard display grid board 17 and the control knob 14 of the sixth preferred embodiment of the present invention is illustrated, which can be used in a touch screen or a pressure sensing panel. The difference of this preferred embodiment from the previous ones is that the control knob 14 is a circular knob engaged with a corresponding circular track slot 113 on the outer shell, where the control knob 14 is confined to follow a rotational adjustment; different control modes correspond to different angular positions of the rotation. Referring to FIG. 8A wherein the control knob 14 is in an angular position labeled “TV” on the upper cover 11. Therefore, the display windows 171 of the keyboard display grid board 17 and the TV key pictures 161a on the printed keyboard 16 are overlapped, so that a user can only control a corresponding television set by either touch screen or a pressure sensing panel.

Referring to FIG. 8B wherein the control knob 14 is rotated clockwise, which is in an angular position labeled “DVD” on the upper cover 11. Therefore, the display windows 171 of the keyboard display grid board 17 and the DVD key pictures 161b on the printed keyboard 16 are overlapped, so that a user can only control a corresponding DVD player by either touch screen or a pressure sensing panel.

Referring to FIG. 8C wherein the control knob 14 further is rotated clockwise being in an angular position labeled “RADIO” on the upper cover 11. Therefore, the display windows 171 of the keyboard display grid board 17 and the RADIO key pictures 161c on the printed keyboard 16 are overlapped, so that a user can only control a corresponding radio by either touch screen or a pressure sensing panel.

Referring to FIG. 8D wherein the control knob 14 yet is rotated clockwise, which is in an angular position labeled “VCR” on the upper cover 11. Therefore, the display windows 171 of the keyboard display grid board 17 and the VCR key pictures 161d on the printed keyboard 16 are overlapped, so that a user can only control a corresponding VCR by either touch screen or a pressure sensing panel.

If the control knob 14 proceeds to move over an angle in the clockwise direction to the position indicating “TV”, the control knob 14 has rotated for a complete round, and the control mode is restored to the status in FIG. 8A. Therefore, the display windows 171 of the keyboard display grid board 17 and the TV key pictures 161a on the printed keyboard 16 are overlapped, so that a user can only control a corresponding television set by either touch screen or a pressure sensing panel.

Referring to FIG. 8E, if-the control knob 14 is rotated for an angle θ1 to switch control mode, the dislocation angular distance θ2 between two sets of adjacent key pictures must be equal to θ1. Or, equivalently, the vertical distance L1 corresponding to the angular distance θ1 equals to the vertical dislocation distance L2 between those two sets of key pictures. If the control knob 14 is rotated for an angle θ3 to switch control mode, the dislocation angular distance θ4 between two sets of key pictures must be equal to θ3. Or, equivalently, the horizontal distance L3 corresponding to the angular distance θ3 equals to the horizontal dislocation distance L4 between those two sets of key pictures. Therefore, the remote controller 10 houses a plurality of sets of key pictures, so that the remote controller 10 can remotely control several devices.

As shown in FIG. 8F, to secure the control knob 14 in selected angular positions, a small round projection 141 is provided on the lateral wall of the control knob 14, and several corresponding recesses 114 are provided on an inner lateral wall of the track slot 113, whereby the small round projection 141 can engage with any of the recesses 114 to achieve a securing effect. It can be a further improvement that the small round projection 141 is replaced by a small steel ball disposed at the exit of a radial hole 143 on the lateral wall of the control knob 14. A spring 142 is inserted in the hole 143 to support the steel ball so that the securing effect between the steel ball and any of the recesses 141 can be further enhanced.

### The Seventh Preferred Embodiment

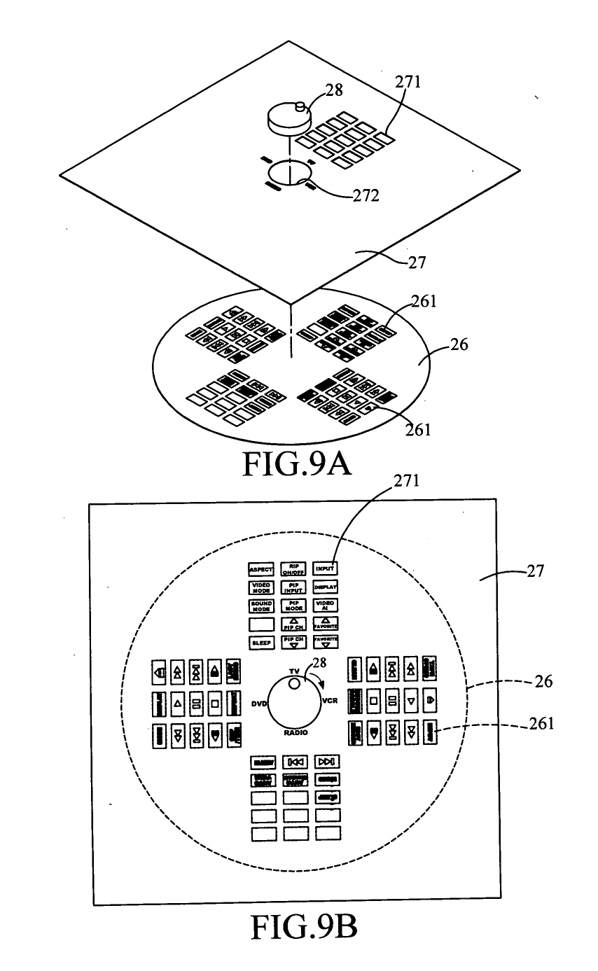

This preferred embodiment is a four mode keypad system with a disk printed keyboard. As shown in FIG. 9A, the printed keyboard 26 is a movable plate of disk shape having a plurality of sets of key pictures 261. (Four sets in the preferred embodiment FIGS. 9A˜9B is shown.) The keyboard display grid board 27 is an immovable plate of rectangular shape situating above the printed keyboard 26; the keyboard display grid board 27 has a set of display windows 271 corresponding to any one set of key pictures 261 on the printed keyboard 26 for showing the touch keys in the windows. The shifting unit of this preferred embodiment is a control knob 28 mounted at the center of the printed keyboard 26. The control knob 28 passes through a hole 272 at the center of the keyboard display grid board 27 and then extends out of a slot (not shown) on the upper cover 11. After assembling which is shown in FIG. 9B, a user rotates the control knob 28 to urge the printed keyboard 26 to rotate accordingly. For every 90 degrees of rotation, a set of key pictures 261 is aligned with the display windows 271 of the keyboard display grid board 27, and therefore a selected control mode is available for controlling a selected appliance.

### The Eighth Preferred Embodiment

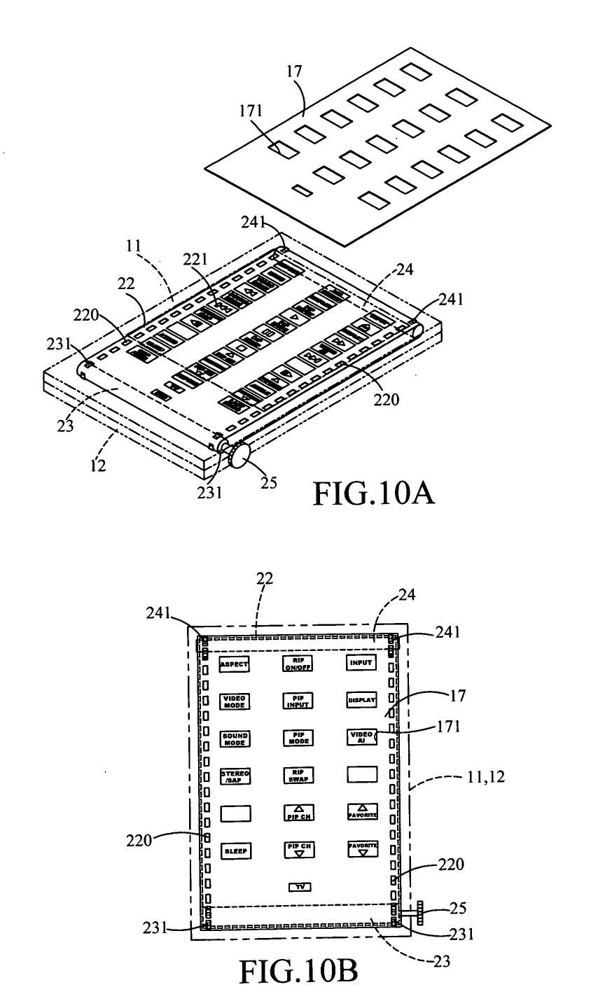

This preferred embodiment is a dual mode key system with a rotary knob and a wheel-driven printed keyboard. As shown in FIG. 10A, the printed keyboard 22, which is operated as a rolling conveyor belt, is scrolled and driven by a roller set; the shifting unit comprises a rotary knob 25 and two rollers 23, 24. The keyboard display grid board 17 is an immovable plate above the printed keyboard 22, and the movable printed keyboard 22 is a rotatable belt with two opposite sides respectively attached to rollers 23, 24 so that the printed keyboard 22 is in a tensioned state. And the rotary knob 25 (the control knob) is situated on the exterior part of the roller 23, which moves the printed keyboard 22 to revolve; otherwise, two ends of the rollers 23, 24 are respectively provided with cogwheels 231, 241 capable of being engaged with the two rows of slide notches 220 arranged along two other opposite sides of the printed keyboard 22. Thereby, the rotary knob 25 can be turned to urge a sliding motion of the printed keyboard 22 under the keyboard display grid board 17. The rotary knob 25 extends out of the outer cover (the upper cover 11 and the lower cover 12) on one lateral side thereof for a user to handle.

According to this preferred embodiment and the seventh preferred embodiment, the printed keyboard 16, 22 or 26 and the keyboard display grid board 17 or 27 may be different in shape, and therefore the movable and immovable plates need not to be referred to a specific part.

### The Ninth Preferred Embodiment

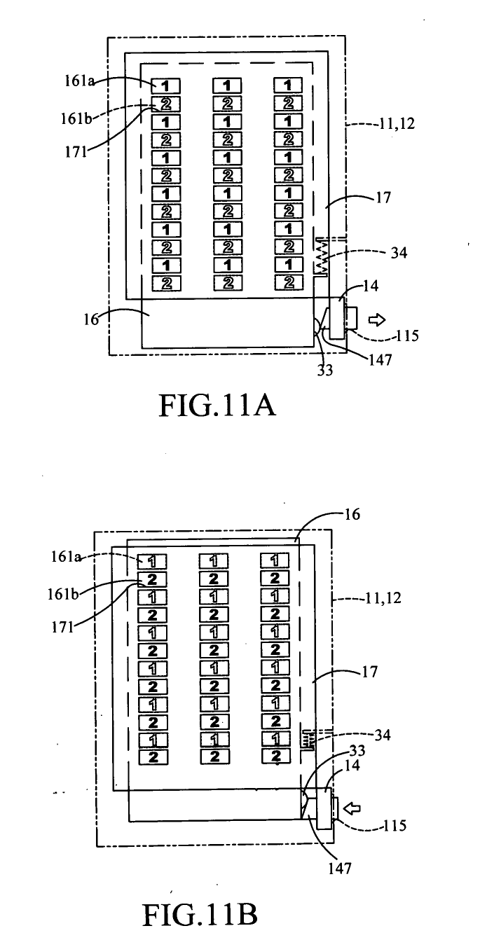

According to the previous preferred embodiments, the shifting unit can be a control knob 15 coupled with a track slot or a rotary control knob 14 coupled with a round slot 113. It can also be a button-type control knob 14 coupled with a buckle slot 115. Referring to FIGS. 11A and 11B, the depression of the control knob 14 into the buckle slot 115 produces a downward shift of the printed keyboard 16 with respect to the outer shell. The shifting unit further includes a push rod 147, a wedge-shaped projection 33 extending from one lateral side of the printed keyboard 16, and a spring 34 tending to restore the printed keyboard 16 to its original configuration.

Therefore, it is known that the shifting unit of the present invention may have a variety of configurations for moving the movable plate, whereby the key pictures 161 displayed by the display windows 171 can be switched.

### The Tenth Preferred Embodiment

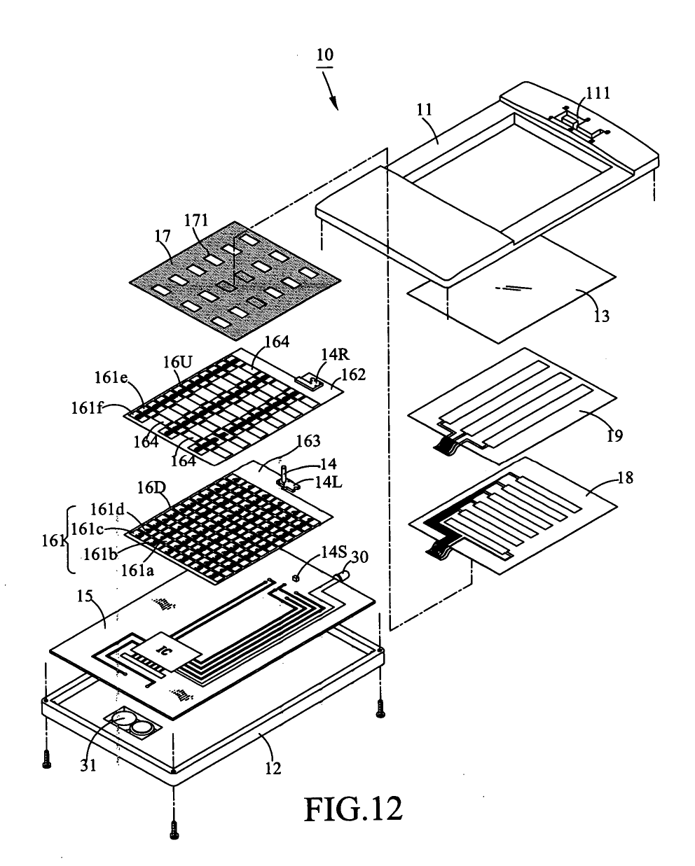

This preferred embodiment is a six mode key system with a plurality of printed keyboards and a keyboard display grid board. As shown in FIG. 12, the keyboard display grid board 17 is the same as that of the previous preferred embodiments, whereas there are two printed keyboards 16U and 16D. A first ridge 162 is extended from the upper right corner of the printed keyboard 16U, and a second ridge 163 is extended from the upper left corner of the printed keyboard 16D. The printed keyboard 16U is partitioned into six rows, in which the odd-number rows, counted from left to right, are provided with a plurality of key pictures 161, whereas the even-number rows are provided with a plurality of display windows 164 for displaying the key pictures 161 on the printed keyboard 16D. The full surface of the printed keyboard 16D is provided with a matrix of key pictures 161.

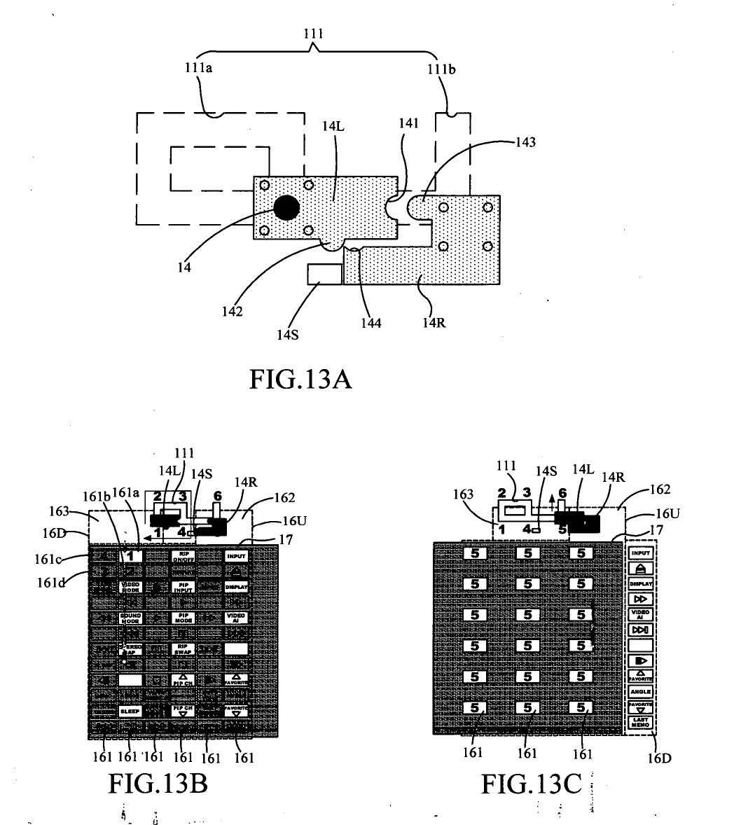

There are two shifting units, which are respectively a right control member 14R and a left control member 14L, as shown in FIG. 13A. The left control member 14L is connected to the printed keyboard 16D, and a control stick 14 is uprightly extended from the left control member 14L, as shown in FIG. 12. A block piece 14S is installed on the keypad circuit board 15 for blocking the right control member 14R moving left. The right side and the bottom side of the left control member 14L are respectively provided with an indentation 141 and a locking piece 142 for being respectively engaged with a bulged piece 143 and a groove 144 on the right control member 14R. Further, the track slot 111 of the shifting units consists of a slot of a rectangular track 111a and an L-shaped track slot 111b, taking a “9”-shape.

The operation procedure of the preferred embodiment is shown in FIG. 13B. Being confined in the rectangular slot 111a, the left control member 14L can slide along the slot 111a clockwise, as indicated by a number sequence 1→2→3→4→1, or counter clockwise, as indicated by a number sequence 1→4→3→2→1, and the lower printed keyboard 16D moves accordingly. Since the keyboard display grid board 17 is immovable and the upper printed keyboard 16U remains still, and the display windows 171, 164 respectively on the keyboard display grid board 17 and the printed keyboard 16U are overlapped, the sets of key pictures 161a to 161d on the printed keyboard 16D will appear subsequently in the overlapped display windows 171, 164.

As shown in FIG. 13C, when the left control member 14L shifts from point 4 to point 5 of the left-side L shaped track slot 111b, it will be first coupled with the right control member 14R and then moves together with 14R to right, and consequently the lower and the upper printed keyboard 16 D, 16U move together to right. Thereby, the key pictures 161e on the upper printed keyboard 16U appear in the display windows 171 of the keyboard display grid board 17. As the left control member 14L moves further to point 6, the right control member 14R will move upward accordingly. Thereby, the key pictures 161f on the upper printed keyboard 16U appear in the display windows 171 of the keyboard display grid board 17.

While the left control member 14L moves back along the original track slot in the reverse direction, 6→5→4, the left side of the right control member 14R is hindered by block piece 14S, the right control member 14R is detached from the left control member 14L. Then the display windows 164 of the upper printed keyboard 16U moved back to coincide with the display windows 171 of the keyboard display grid board 17, they are overlapped, thus the set of key pictures 161a˜161d of the lower printed keyboard 16D subsequently appears through the rectangular track 111a as the left control member 14L moves along its path.

Likewise, the number of the printed keyboard 16 in this preferred embodiment can be more than two, and therefore more shifting units are needed. The principle is that the upper a printed keyboard is, the more windows 164 it has, and that the lowest printed keyboard 16 has no windows but keys. Thereby, the remote controller 10 has a variety of control modes.

### The Eleventh Preferred Embodiment

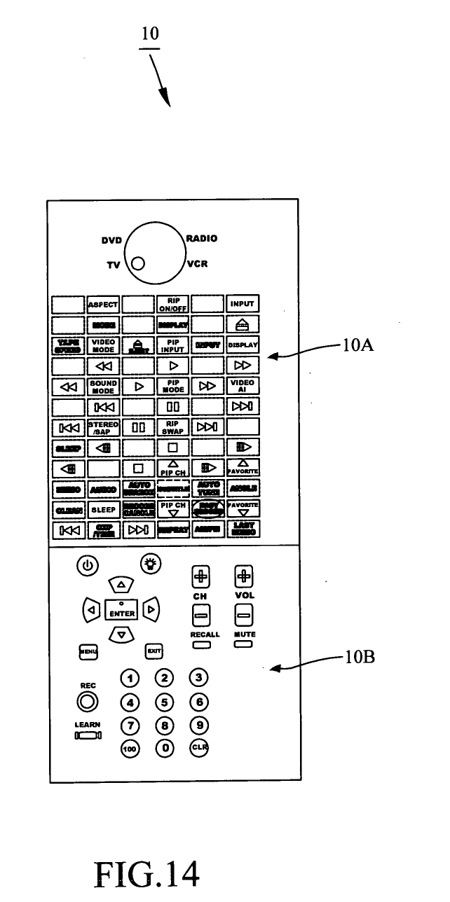

This preferred embodiment is a multimode key system with a conventional fixed keypad module. As shown in FIG. 14, the multimode keypad module 10A comprises a control knob 14, a printed keyboard 16 and a keyboard display grid board 17, which is the same as what disclosed in FIG. 8 (the sixth preferred embodiment). However, the remote controller 10 has a conventional fixed keypad module 10B. Thereby, the combination of the multimode keypad module 10A and the fixed keypad module 10B can provide more versatile control functions.

### The Twelfth Preferred Embodiment

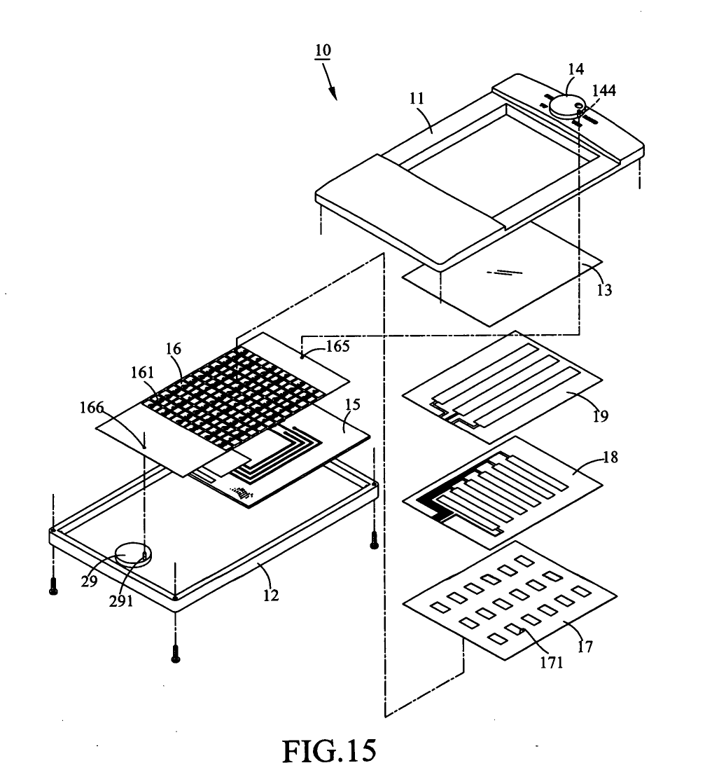

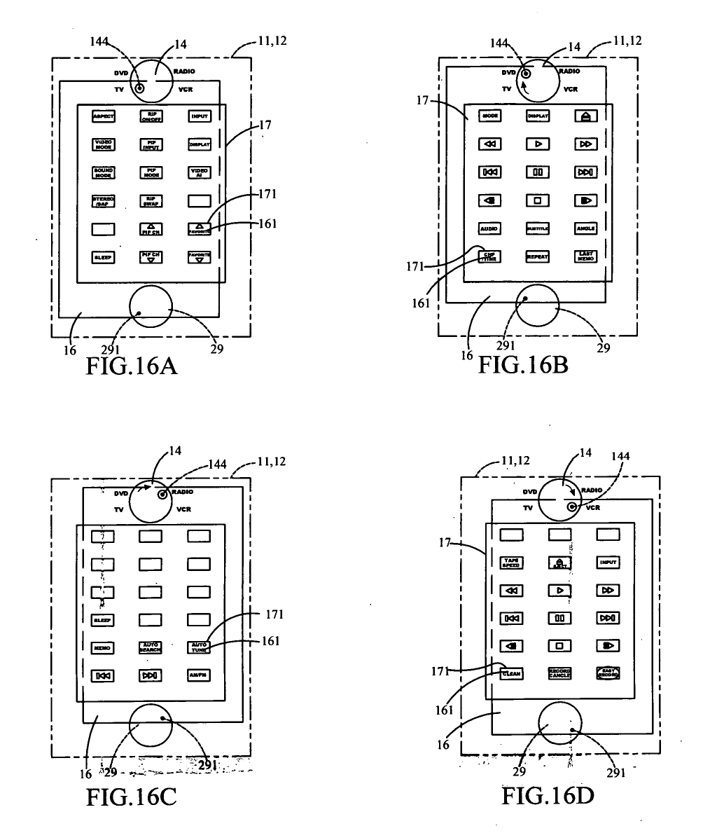

As shown in FIG. 15, the twelfth preferred embodiment of the present invention as a multimode key system, apart from the shifting unit, is similar to the sixth preferred embodiment (as shown in FIG. 8). To assure synchronic shifting between the upper end and the lower end of the printed keyboard 16, a support pin 144 is attached to the bottom face of the control knob 14 on the upper cover 11 and goes through an upper through hole 165 on the printed keyboard 16. Another support pin 291 is attached to a rotary knob 29 pivotally mounted on the lower cover 12 and goes through a lower thought hole 166 on the printed keyboard 16. Thereby, as the control knob 14 is rotated and the printed keyboard 16 moves accordingly, the rotary knob 29 rotates in the same direction, assuring the lower portion of the printed keyboard 16 moves with the upper portion at the same path collaterally and preventing the printed keyboard 16 turning obliquely. This effect can be visualized by going through FIGS. 16A to 16D.

### The Thirteenth Preferred Embodiment

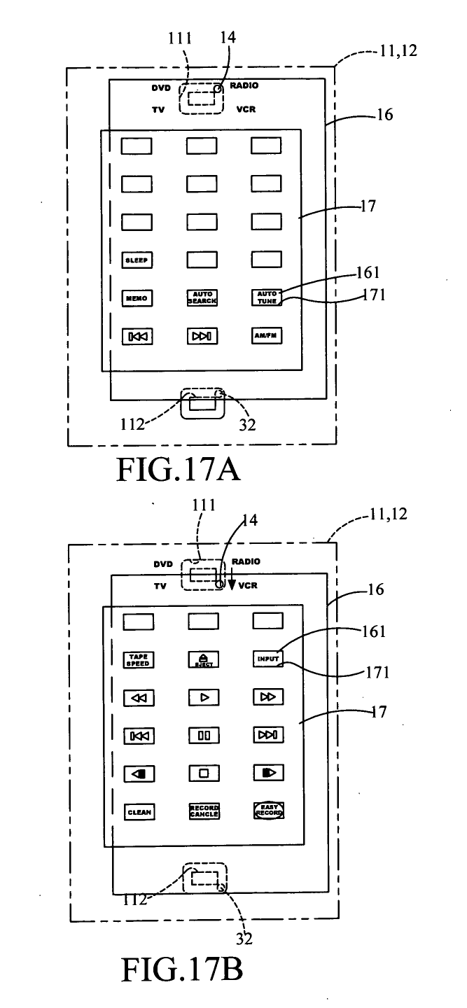

As shown in FIG. 17A, the thirteenth preferred embodiment of the present invention as a multimode key system is similar to the third preferred embodiment (as shown in FIG. 5), except for a mechanism for assuring a collateral movement of the upper and the lower sides of the printed keyboard 16. The control knob 14 of the upper cover 11 is connected to the printed keyboard 16 through a support pin, and the lower end of the printed keyboard 16 is engaged with a bulged piece 32. The bulged piece 32 situates in a track slot 112 on the lower cover 12 and is in a symmetric position with respect to the control knob 14. Thereby, as the control knob 14 is shifted and the printed keyboard 16 moves accordingly, the bulged piece 32 performed a collateral movement, as shown in FIG. 17B, which prevents the printed keyboard 16 turning obliquely during a mode changing process.

Further, the control knob 14 of the shifting unit can also be a joystick (not disclosed in the drawings), thereby the translation or rotation of the joystick urging the movement of either printed keyboard 16 or keyboard display grid board 17, and thereby the key pictures 161 shown in the display windows 171 can be switched.

### The Fourteenth Preferred Embodiment

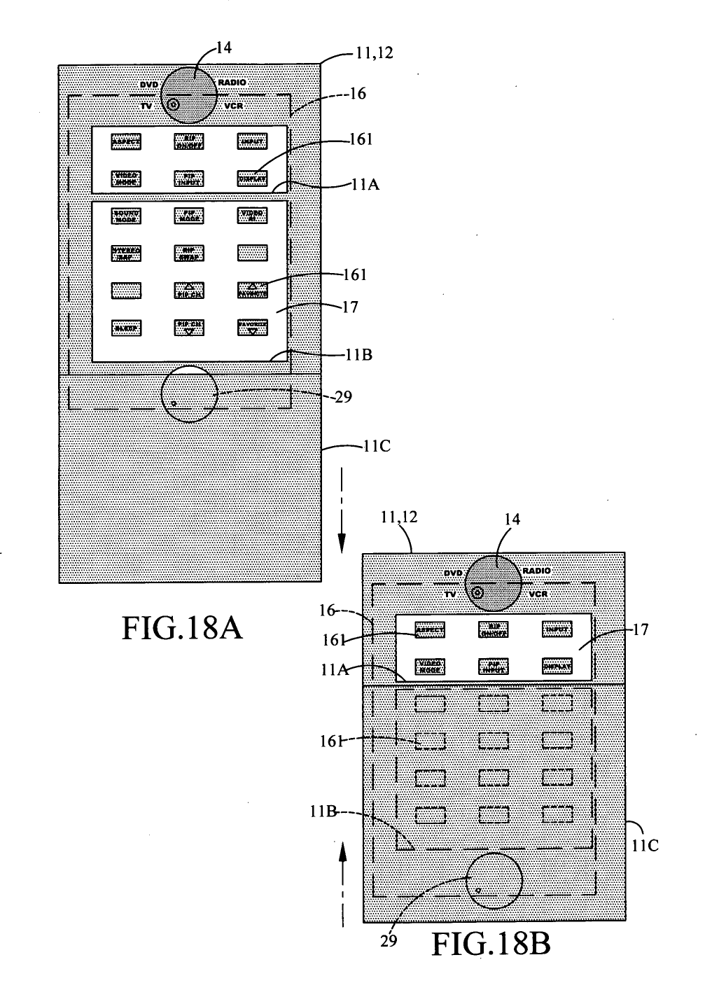

As shown in FIG. 18A, the fourteenth preferred embodiment of the present invention as a multimode key system is similar to the twelfth preferred embodiment (as shown in FIG. 15), except that in this preferred embodiment there are two viewing windows on the upper cover 11, one for keys commonly used (the main window 11A) and the other for keys less frequently used (the secondary window 11B). The secondary window 11B is usually covered by a slidable cover 11C, as shown in FIG. 18B. Therefore, the number of visible keys is reduced and the operation simplified. When a less frequently used key is needed, a user simply shift the sliding cover to an open state. As a user turns the control knob 14, the key pictures shown in both of the main and the secondary windows are switched.

Likewise, the present invention can be embodied with a plurality of viewing windows, which can be applied to the previously described preferred embodiments.

### The Fifteenth Preferred Embodiment

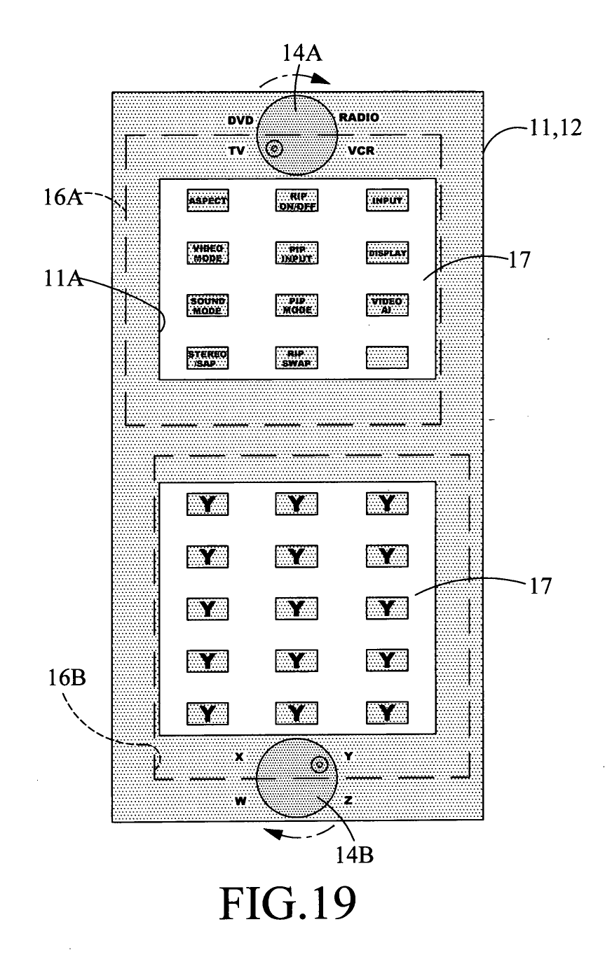

As shown in FIG. 19, the fifteenth preferred embodiment of the present invention as a multimode key system includes a main movable plate and a secondary movable plate. Herein this preferred embodiment, the main and the secondary movable plates are respectively an upper printed keyboard 16A and a lower printed keyboard 16B. The upper printed keyboard 16A and the lower printed keyboard 16B may be respectively aligned with the main viewing window 11A and the secondary viewing window 11B. The main and the secondary movable plates are respectively attached with a shifting mechanism (e.g., control knob 14A, 14B) for activating shifting motions of the upper printed keyboard 16A and the lower printed keyboard 16B. To further facilitate the operation, the less frequently used keys are arranged on the secondary movable plate, whereas the more frequently used keys are arranged on the main movable plate.

Likewise, the main and the secondary movable plates can also be an upper keyboard display grid board and a lower keyboard display grid board. And the number of movable plates can be more than two.

The present invention is applied not only to a remote controller 10 but also to control panels for various appliances and industrial apparatuses. Therefore, the application range is very wide.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

1. A multimode key system, comprising:
an outer shell with at least one viewing window;
a shifting unit combined with said outer shell for a user to operate;
a sensing circuit module hidden within said outer shell;
a movable plate disposed in said outer shell coupled with said shifting unit, whereby said movable plate can be moved by shifting said shifting unit; and
an immovable plate situating a corresponding parallel position of said movable plate to form a moving mechanism;
whereby, one of above plates being a keyboard display grid board with a plurality of display windows formed at predetermined locations; and
second plate situating under, behind previous plate in a slidable contact, being a printed keyboard having a plurality of sets of key pictures;
whereby said shifting unit can urge said movable plate to move so as to form a slide dislocation between said movable plate and said immovable plate, and whereby any set of key pictures can be selected to appear in said display windows on said immovable plate for switching said multimode key system to a desired control mode.

2. The multimode key system of claim 1 wherein said shifting unit is a control knob confined in a track slot on said outer shell and connected to said movable plate so as to move said movable plate in accordance with said control knob.

3. The multimode key system of claim 1 wherein said shifting unit is a control knob confined in a track slot on said outer shell, whereby said control knob can be rotated to urge said movable plate to move accordingly.

4. The multimode key system of claim 1 wherein said shifting unit is a control knob confined in a buckle slot on said outer shell, whereby said control knob can be pressed downward to urge said movable plate to move accordingly.

5. The multimode key system of claim 1 wherein said sensing circuit module further comprises:
a keypad circuit board disposed in said outer shell, said printed keyboard being mounted on said keypad circuit board; and
a set of transverse and longitudinal sensing pieces situated on said keyboard display grid board;
whereby said sensing circuit module becomes a multimode key system of touch screen type.

6. The multimode key system of claim 1 wherein said sensing circuit module further comprises:
a keypad sensing circuit board disposed in said outer shell; and
a touch key activation plate sandwiched by said keypad sensing circuit board and said printed keyboard;
whereby said sensing circuit module becomes a multimode key system of pressure sensing type.

7. The multimode key system of claim 1 wherein said viewing window on said outer shell is further provided with a transparent screen protection cover.

8. The multimode key system of claim 1 having a plurality of movable plates, wherein said keyboard display grid board is fixed, and at least two said printed keyboards act as movable plates; the upper said printed keyboards have more windows and fewer key pictures, but the lower said printed keyboards have less windows and more key pictures, and the lowest said printed keyboard has no windows but key pictures, wherein each of said printed keyboards is connected to a shifting unit, wherein one of said shifting units has a control knob for a user to operate, and wherein said shifting units other than said shifting unit having a control knob are coupled with said shifting unit having a control knob for moving a plurality of said printed keyboards simultaneously.

9. The multimode key system of claim 1 wherein said movable plate is a rotatable belt. The shifting mechanism for controlling said movable plate is a rolling belt set having two rollers respectively connected to an upper side and a lower side of said printed keyboard and capable of producing a tension over said printed keyboard so that, as a rotary knob of one said roller is turned, the other said roller rotates accordingly and said printed keyboard can slide between said rollers.

10. The multimode key system of claim 9 wherein two sides of the two rollers are added with cogs for being engaged to the slide notches at two sides of the printed keyboard for rotation.

11. The multimode key system of claim 3 further including a passive rotary knob installed on a side of said movable plate opposite to said control knob, whereby said passive rotary knob can rotate collaterally with said control knob when said control knob is turned.

12. The multimode key system of claim 2 further including a passive shifting unit installed on a side of said movable plate opposite to said control knob, whereby said passive shifting unit can move collaterally with said control knob when said control knob is shifted.

13. The multimode key system of claim 1 wherein the number of said viewing windows on said outer shell is more than one.

14. The multimode key system of claim 1 wherein the number of said movable plates is more than one, each of said movable plates being connected to respective said shifting unit.
